(19) United States
(12) Patent Application Publication
(10) Pub. No.: US 2004/0207622 A1
(43) Pub. Date: Oct. 21, 2004

(54) Efficient implementation of shading language programs using controlled partial evaluation

(76) Inventors: Michael F. Deering, Los Altos, CA (US); Douglas C. Twilleager, Oakland, CA (US); Daniel S. Rice, Oakland, CA (US)

Correspondence Address: Jeffrey C. Hood, Meyertons, Hood, Kivlin, Kowert & Goetzel, PC, P.O. Box 398, Austin, TX, 78767, US

(21) Appl. No.: 10/403,837

(22) Filed: Mar. 31, 2003

(51) Int. Cl. G06T 15/50

(52) U.S. Cl. 345/426

(57) ABSTRACT

A graphical computing system including a host processor and a target processor. In response to execution of stored instructions, the host processor is operable to: (a) receive input code for a program and a set of constraints on input variables of the program, (b) compile a specialized version V_{K} of the input code for each constraint C_{K} of said constraint set and store the specialized version V_{K} in a local memory, (c) receive particular values of the input variables in response to a run-time invocation of the program, (d) search the constraint set to determine if the particular values satisfy any of the constraints of the constraint set, and (e) in response to determining that the particular values satisfy a constraint C_{L} of the constraint set, invoking execution of the specialized version V_{L} by the target processor.

### BACKGROUND OF THE INVENTION

1. Field of the Invention

This invention relates generally to the field of computer graphics and, more particularly, to a compiler system and method for maximizing (or increasing) the execution efficient of shaders on programmable processors.

2. Description of the Related Art

A shading function, or “shader”, is a function that may be called on every vertex of a three-dimensional model. Thus, it is important to reduce (or eliminate) redundant computations to deliver the best possible performance.

Shaders are typically written to achieve a generic “look” such as bumpy plastic, wood grain, skin, etc. When a shader is applied to a particular object, a number of parameters are specified to determine the look of that object, such as the amount of bumpiness, the underlying color of the wood, or the wrinkliness of the skin. In some software systems, the shader is additionally responsible for computing the interaction of light with the surface, which requires an additional set of parameters to control shininess, directionality, etc. The result is often a complex shader program with many features, only a fraction of which are used by any particular instance. Designers may prefer to deal with a small number of very complex but capable shaders, rather than having to choose between a larger number of specialized shaders.

One way to bridge the gap between functionality and performance is to perform automated specialization of the shader code when it is instanced. For example, if a shader computes a lighting equation such as

K=Ks*specular+Kd*diffuse+Ka,

and the input parameter Ks is set to 0 (as would be the case for a purely diffuse surface), the equation can be rewritten as

K=Kd*diffuse+Ka.

Since the equation is evaluated at every pixel, the savings due to this specialization of the program code can be substantial.

Program specialization (also known as partial evaluation) is well known in the computer science literature. The application to shaders was described in a paper by Brian Guenter, Todd B. Knoblock and Erik Ruf entitled “Specializing shaders”, in the Proceedings of the 22nd annual conference on Computer graphics and interactive techniques, p.343-350, September 1995. However, the question of when and how specialization is to take place in a real-time graphics system with hardware shading support has not been addressed.

Until recently, programmable shaders appeared only in batch-oriented software rendering systems. Each frame could take minutes or hours to compute. Shaders were typically compiled into an intermediate form, which was then interpreted during rendering. This interpretation could be done relatively efficiently by performing each processing step on a large number of pixels before going on to the next step.

Real-time shading systems have recently appeared, but they mainly make use of low-level languages that require minimal compilation. There exists a need for a real-time shading system and method capable of using a high-level language.

In a real-time shading system, a compiler maps the shader code onto a machine language understood by the hardware. The mapping process may be CPU-intensive because the output code needs to be compact and because the capabilities of the target graphics hardware may be quite limited. Therefore, recompiling a shader every time an input parameter is changed may result in unacceptable delays. Thus, there exists a need for an improved system and method for operating a shading system.

### SUMMARY

Various embodiments disclosed herein contemplate a shader language with features that facilitate ahead-of-time specialization of shaders. When an input parameter is changed, a pre-compiled version of the shader may be selected, conserving effort at runtime.

In one set of embodiments, a graphical computing system may include a host processor and a programmable target processor. In response to the execution of stored instructions, the host processor is operable to: (a) receive input code for a program and a set of constraints on input variables of the program, (b) compile a specialized version V_{K} of the input code for each constraint C_{K} of the constraint set and store the specialized version V_{K} in a local memory, (c) receive particular values of the input variables in response to a run-time invocation of the program, (d) search the constraint set to determine if the particular values satisfy any of the constraints of the constraint set, and (e) in response to determining that the particular values satisfy a constraint C_{L} of the constraint set, invoking execution of the specialized version V_{L} by the target processor.

The step of invoking execution of the specialized version V_{L} may involve transferring the specialized version V_{L} from the local memory to the target processor. The target processor may execute the specialized version V_{L} for each vertex in a set of vertices. The vertices may be vertices of micropolygons (e.g., trimmed pixels) generated by one or more tessellation processes.

The target processor may be part of a graphics rendering agent configured to receive graphics data and to generate displayable pixels in response to the graphics data. In some embodiments, the graphics rendering agent is a graphics accelerator system.

In another set of embodiments, a method for implementing a compiler may involve the steps of:

(a) receiving input code for a program and a set of one or more constraints on input variables of the program;

(b) compiling a specialized version V_{K} of the input code for each constraint C_{K} of the constraint set and storing the specialized version V_{K} in a local memory;

(c) receiving particular values of the input variables in response to a run-time invocation of the program;

(d) searching the constraint set to determine if the particular values satisfy any of the constraints of the constraint set; and

(e) in response to determining that the particular values satisfy a constraint C_{L} of the constraint set, invoking execution of the corresponding specialized version V_{L} by a target processor.

The step of invoking execution of the specialized version V_{L} may involve transferring the specialized version V_{L} from the local memory to the target processor. The target processor may execute the specialized version V_{L} for each vertex in a set of vertices.

### BRIEF DESCRIPTION OF THE DRAWINGS

A better understanding of the present invention can be obtained when the following detailed description is considered in conjunction with the following drawings, in which:

FIG. 1 illustrates one set of embodiments of a graphics rendering pipeline;

FIG. 2A illustrates one embodiment of a triangle fragmentation process;

FIG. 2B illustrates several termination criteria for a triangle fragmentation process;

FIG. 3A illustrates one embodiment of a quadrilateral fragmentation process;

FIG. 3B illustrates several termination criteria for a quadrilateral fragmentation process;

FIG. 4 illustrates one embodiment of a fragmentation process that operates on triangles to generate component quadrilaterals;

FIGS. 5A and 5B illustrate one embodiment of a method for fragmenting a primitive based on render pixels;

FIG. 6 illustrates a triangle in camera space and its projection into render pixel space;

FIG. 7 illustrates a process for filling a micropolygon with samples;

FIG. 8 illustrates an array of virtual pixel positions superimposed on an array of render pixels in render pixel space;

FIG. 9 illustrates the computation of a pixel at a virtual pixel position (denoted by the plus marker) according to one set of embodiments; and

FIG. 10 illustrates one set of embodiments of computational system configured to perform graphical rendering computations;

FIG. 11 illustrates one embodiment of a graphics system configured to perform per pixel programming shading;

FIG. 12 illustrates one embodiment of a graphics computing system configured to perform ahead-of-time specialization of an input program to reduce compilation effort at runtime;

FIG. 13 illustrates one embodiment of a method for performing ahead-of-time specialization of an input program to reduce compilation effort at runtime; and

FIG. 14 illustrates one embodiment of method for governing the run-time execution of a compiler.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

Various Spaces

Model Space: The space in which an object (or set of objects) is defined.

Virtual World Space: The space in which a scene comprising a collection of objects and light sources may be constructed. Each object may be injected into virtual world space with a transformation that achieves any desired combination of rotation, translation and scaling of the object. In older terminology, virtual world space has often been referred to simply as “world space”.

Camera Space: A space defined by a transformation T^{VC} from virtual world space. The transformation T^{VC} may achieve a combination of translation, rotation, and scaling. The translation and rotation account for the current position and orientation of a virtual camera in the virtual world space. The coordinate axes of camera space are rigidly bound to the virtual camera. In OpenGL, camera space is referred to as “eye space”.

Clipping Space: A space defined by a transform T^{CX} from camera space before any perspective division by the W coordinate, and is used as an optimization in some clipping algorithms. In clipping space, the sides of the perspective-projection view volume may occur on the bounding planes X=±W, Y=±W, Z=0 and Z=−W. Clipping space is not mandated by the abstract rendering pipeline disclosed herein, and is defined here as a convenience for hardware implementations that choose to employ it.

Image Plate Space: A two-dimensional space with a normalized extent from −1 to 1 in each dimension, created after perspective division by the W coordinate of clipping space, but before any scaling and offsetting to convert coordinates into render pixel space).

Pixel Plate Space: A two-dimensional space created after perspective division by the W coordinate of camera space, but before any scaling and offsetting to convert coordinates into render pixel space.

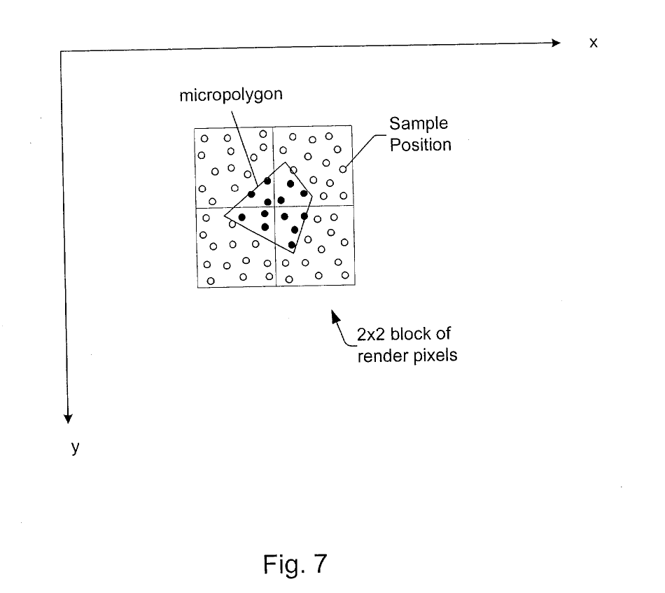

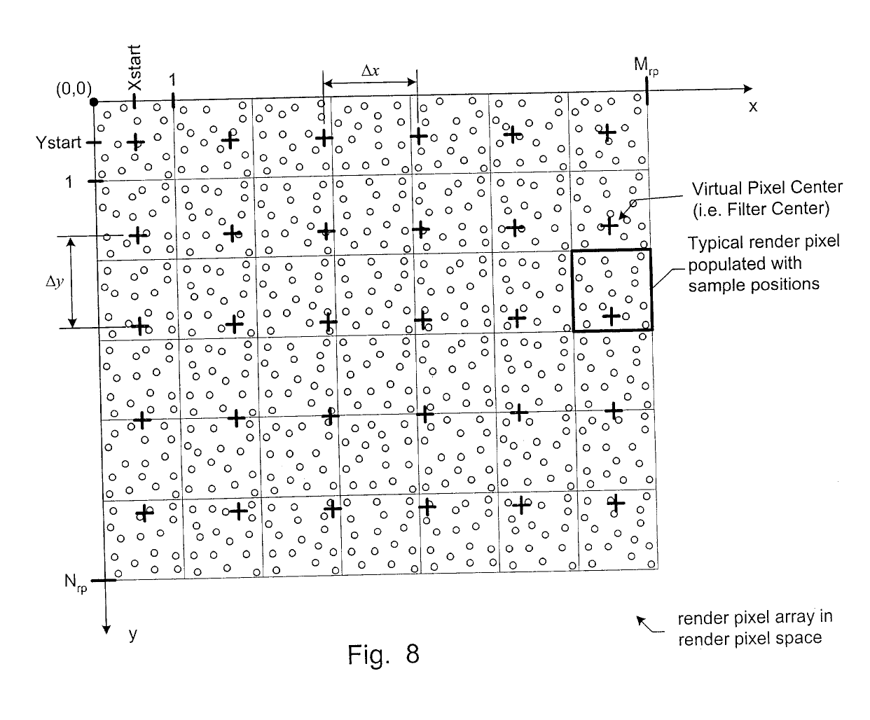

Render Pixel Space: A space defined by a transform T^{IR} from image plate space (or a transform T^{JR} from pixel plate space). The transform T^{IR} (or T^{JR}) scales and offsets points from image plate space (or pixel plate space) to the native space of the rendered samples. See FIGS. 7 and 8.

Video Pixel Space: According to the abstract rendering pipeline defined herein, a filtering engine generates virtual pixel positions in render pixel space (e.g., as suggested by the plus markers of FIG. 8), and may compute a video pixel at each of the virtual pixel positions by filtering samples in the neighborhood of the virtual pixel position. The horizontal displacement Δx and vertical displacement Δy between virtual pixel positions are dynamically programmable values. Thus, the array of virtual pixel positions is independent of the array of render pixels. The term “video pixel space” is used herein to refer to the space of the video pixels.

Texture Vertex Space: The space of the texture coordinates attached to vertices. Texture vertex space is related to texture image space by the currently active texture transform. (Effectively, every individual geometry object defines its own transform from texture vertex space to model space, by the association of the position, texture coordinates, and possibly texture coordinate derivatives with all the vertices that define the individual geometry object.)

Texture Image Space: This is a space defined by the currently active texture transform. It is the native space of texture map images.

Light Source Space: A space defined by a given light source.

Abstract Rendering Pipeline

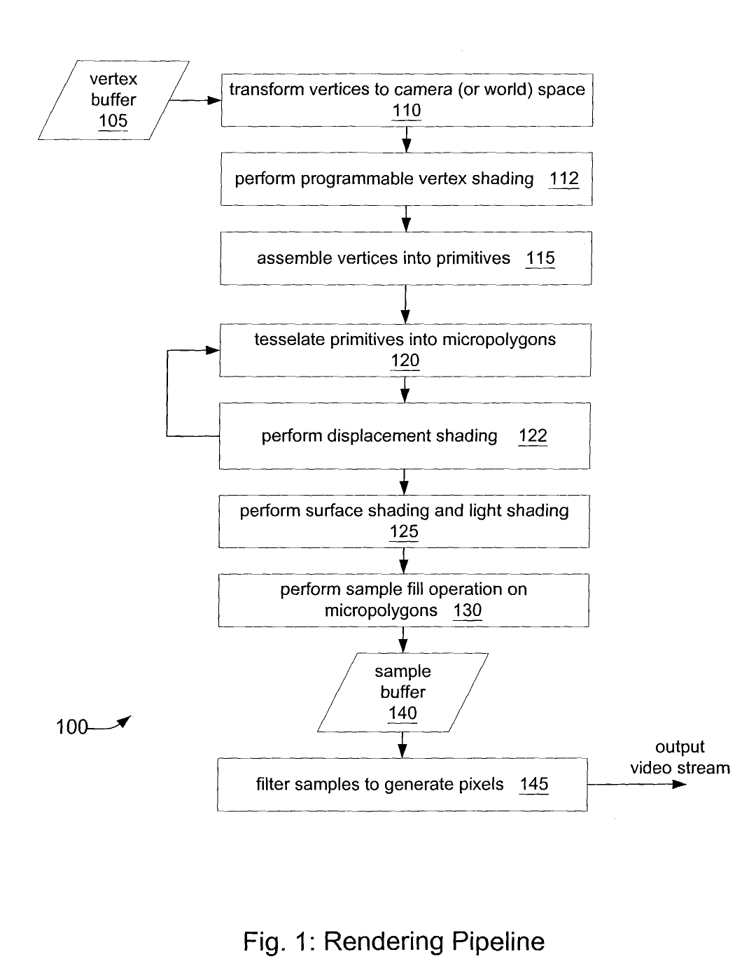

FIG. 1 illustrates a rendering pipeline 100 that supports per-pixel programmable shading. The rendering pipeline 100 defines an abstract computational model for the generation of video pixels from primitives. Thus, a wide variety of hardware implementations of the rendering pipeline 100 are contemplated.

Vertex data packets may be accessed from a vertex buffer 105. A vertex data packet may include a position, a normal vector, texture coordinates, texture coordinate derivatives, and a color vector. More generally, the structure of a vertex data packet is user programmable. As used herein the term vector denotes an ordered collection of numbers.

In step 110, vertex positions and vertex normals may be transformed from model space to camera space or virtual world space. For example, the transformation from model space to camera space may be represented by the following expressions:

X^{C}=T^{MC}X^{M},

N^{C}=G^{MC}n^{M}.

If the normal transformation G^{MC} is not length-preserving, the initial camera space vector N^{C} may be normalized to unit length:

n^{C}=N^{C}/length(N^{C}).

For reasons that will become clear shortly, it is useful to maintain both camera space (or virtual world space) position and render pixel space position for vertices at least until after tessellation step 120 is complete. (This maintenance of vertex position data with respect to two different spaces is referred to herein as “dual bookkeeping”.) Thus, the camera space position X^{C} may be further transformed to render pixel space:

X^{R}=T^{CR}X^{C}.

The camera-space-to-render-pixel-space transformation T^{CR} may be a composite transformation including transformations from camera space to clipping space, from clipping space to image plate space (or pixel plate space), and from image plate space (or pixel plate space) to render pixel space.

In step 112, one or more programmable vertex shaders may operate on the camera space (or virtual world space) vertices. The processing algorithm performed by each vertex shader may be programmed by a user. For example, a vertex shader may be programmed to perform a desired spatial transformation on the vertices of a set of objects.

In step 115, vertices may be assembled into primitives (e.g. polygons or curved surfaces) based on connectivity information associated with the vertices. Alternatively, vertices may be assembled into primitives prior to the transformation step 110 or programmable shading step 112.

In step 120, primitives may be tessellated into micropolygons. In one set of embodiments, a polygon may be declared to be a micropolygon if the projection of the polygon in render pixel space satisfies a maximum size constraint. The nature of the maximum size constraint may vary among hardware implementations. For example, in some implementations, a polygon qualifies as a micropolygon when each edge of the polygon's projection in render pixel space has length less than or equal to a length limit Lₘₐₓ in render pixel space. The length limit Lₘₐₓ may equal one or one-half. More generally, the length limit Lₘₐₓ may equal a user-programmable value, e.g., a value in the range [0.5,2.0].

As used herein the term “tessellate” is meant to be a broad descriptive term for any process (or set of processes) that operates on a geometric primitive to generate micropolygons.

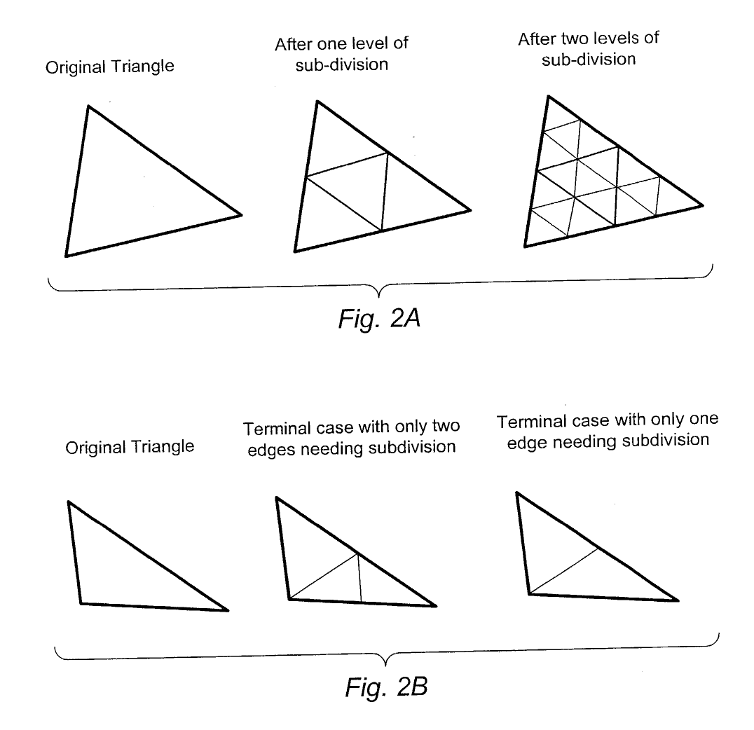

Tessellation may include a triangle fragmentation process that divides a triangle into four subtriangles by injecting three new vertices, i.e, one new vertex at the midpoint of each edge of the triangle as suggested by FIG. 2A. The triangle fragmentation process may be applied recursively to each of the subtriangles. Other triangle fragmentation processes are contemplated. For example, a triangle may be subdivided into six subtriangles by means of three bisecting segments extending from each vertex of the triangle to the midpoint of the opposite edge.

FIG. 2B illustrates means for controlling and terminating a recursive triangle fragmentation. If a triangle resulting from an application of a fragmentation process has all three edges less than or equal to a termination length Lₜₑᵣₘ, the triangle need not be further fragmented. If a triangle has exactly two edges greater than the termination length Lₜₑᵣₘ (as measured in render pixel space), the triangle may be divided into three subtriangles by means of a first segment extending from the midpoint of the longest edge to the opposite vertex, and a second segment extending from said midpoint to the midpoint of the second longest edge. If a triangle has exactly one edge greater than the termination length Lₜₑᵣₘ, the triangle may be divided into two subtriangles by a segment extending from the midpoint of the longest edge to the opposite vertex.

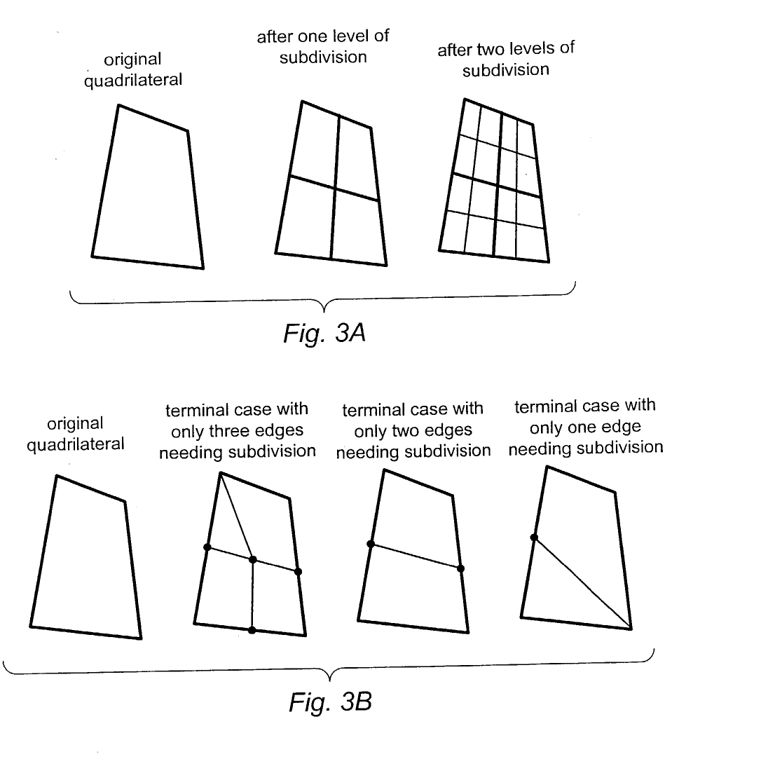

Tessellation may also include a quadrilateral fragmentation process that fragments a quadrilateral into four subquadrilaterals by dividing along the two bisectors that each extend from the midpoint of an edge to the midpoint of the opposite edge as illustrated in FIG. 3A. The quadrilateral fragmentation process may be applied recursively to each of the four subquadrilaterals.

FIG. 3B illustrates means for controlling and terminating a recursive quadrilateral fragmentation. If a quadrilateral resulting from an application of the quadrilateral fragmentation process has all four edges less than or equal to the termination length Lₜₑᵣₘ, the quadrilateral need not be further fragmented. If the quadrilateral has exactly three edges greater than the termination length Lₜₑᵣₘ, and the longest and second longest edges are nonadjacent, the quadrilateral may be divided into three subquadrilaterals and a triangle by means of segments extending from an interior point to the midpoints of the three longest edges, and a segment extending from the interior point to the vertex which connects the smallest edge and longest edge. (The interior point may be the intersection of the two lines which each extend from an edge midpoint to the opposite edge midpoint.) If the quadrilateral has exactly two sides greater than the termination length limit Lₜₑᵣₘ, and the longest edge and the second longest edge are nonadjacent, the quadrilateral may be divided into two subquadrilaterals by means of a segment extending from the midpoint of the longest edge to the midpoint of the second longest edge. If the quadrilateral has exactly one edge greater than the termination length Lₜₑᵣₘ, the quadrilateral may be divided into a subquadrilateral and a subtriangle by means of a segment extending from the midpoint of the longest edge to the vertex which connects the second longest edge and the third longest edge. The cases given in FIG. 3B are not meant be an exhaustive list of termination criteria.

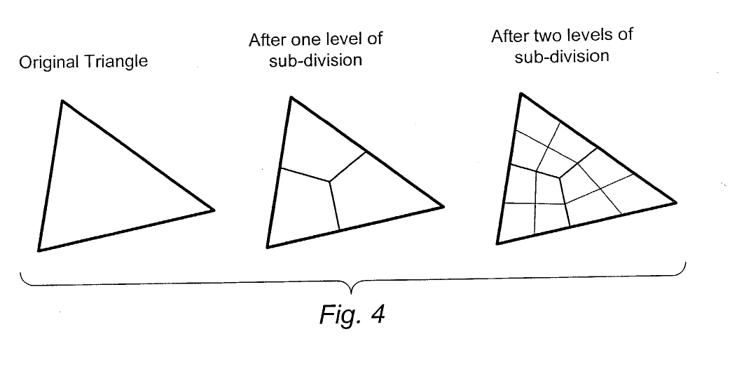

In some embodiments, tessellation may include algorithms that divide one type of primitive into components of another type. For example, as illustrated in FIG. 4, a triangle may be divided into three subquadrilaterals by means of segments extending from an interior point (e.g. the triangle centroid) to the midpoint of each edge. (Once the triangle has been the divided into subquadrilaterals, a quadrilateral fragmentation process may be applied recursively to the subquadrilaterals.) As another example, a quadrilateral may be divided into four subtriangles by means of two diagonals that each extend from a vertex of the quadrilateral to the opposite vertex.

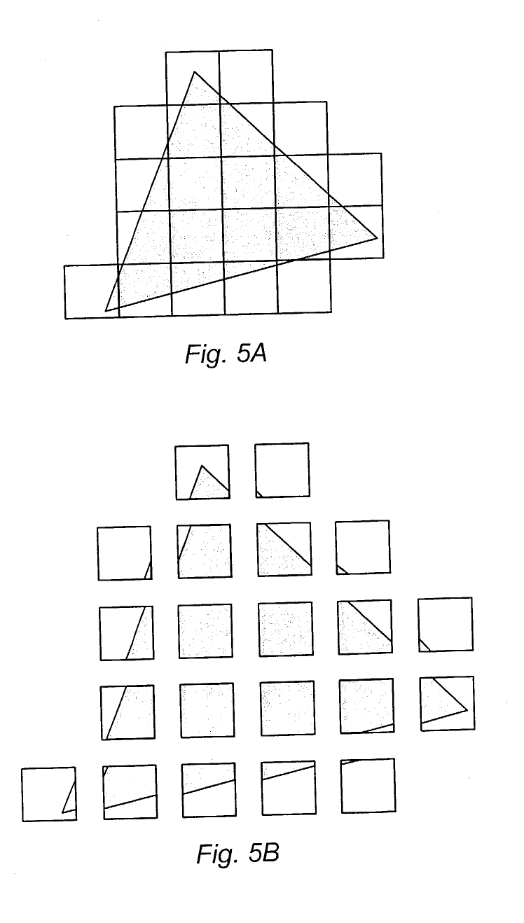

In some embodiments, tessellation may involve the fragmentation of primitives into micropolygons based on an array of render pixels as suggested by FIGS. 5A and 5B. FIG. 5A depicts a triangular primitive as seen in render pixel space. The squares represent render pixels in render pixel space. Thus, the primitive intersects 21 render pixels. Seventeen of these render pixels are cut by one or more edges of the primitive, and four are completely covered by the primitive. A render pixel that is cut by one or more edges of the primitive is referred to herein as a trimmed render pixel (or simply, trimmed pixel). A render pixel that is completely covered by the primitive is referred to herein as a microsquare.

The tessellation process may compute edge-trimming information for each render pixel that intersects a primitive. In one implementation, the tessellation process may compute a slope for an edge of a primitive and an accept bit indicating the side of the edge that contains the interior of the primitive, and then, for each render pixel that intersects the edge, the tessellation process may append to the render pixel (a) the edge's slope, (b) the edge's intercept with the boundary of the render pixel, and (c) the edge's accept bit. The edge-trimming information is used to perform sample fill (described somewhat later).

FIG. 5B illustrates an exploded view of the 21 render pixels intersected by the triangular primitive. Observe that of the seventeen trimmed render pixels, four are trimmed by two primitive edges, and the remaining thirteen are trimmed by only one primitive edge.

In some embodiments, tessellation may involve the use of different fragmentation processes at different levels of scale. For example, a first fragmentation process (or a first set of fragmentation processes) may have a first termination length which is larger than the length limit Lₘₐₓ. A second fragmentation process (or a second set of fragmentation processes) may have a second termination length which is equal to the length limit Lₘₐₓ. The first fragmentation process may receive arbitrary sized primitives and break them down into intermediate size polygons (i.e. polygons that have maximum side length less than or equal to the first termination length). The second fragmentation process takes the intermediate size polygons and breaks them down into micropolygons (i.e., polygons that have maximum side length less than or equal to the length limit Lₘₐₓ).

The rendering pipeline 100 may also support curved surface primitives. The term “curved surface primitive” covers a large number of different non-planar surface patch descriptions, including quadric and Bezier patches, NURBS, and various formulations of sub-division surfaces. Thus, tessellation step 120 may include a set of fragmentation processes that are specifically configured to handle curved surfaces of various kinds.

Given an edge (e.g. the edge of a polygon) defined by the vertices V₁ and V₂ in camera space, the length of the edge's projection in render pixel space may be computed according to the relation ∥v₂−v₁∥, where v₁ and v₂ are the projections of V₁ and V₂ respectively into render pixel space, where ∥*∥ denotes a vector norm such as the L¹ norm, the L^{∞} norm, or Euclidean norm, or, an approximation to a vector norm. The L¹ norm of a vector is the sum of the absolute values of the vector components. The L^{∞} norm of a vector is the maximum of the absolute values of the vector components. The Euclidean norm of a vector is the square root of the sum of the squares of the vector components.

In some implementations, primitives may be tessellated into “microquads”, i.e., micropolygons with at most four edges. In other implementations, primitives may be tessellated into microtriangles, i.e., micropolygons with exactly three edges. More generally, for any integer Ns greater than or equal to three, a hardware system may be implemented to subdivide primitives into micropolygons with at most Ns sides.

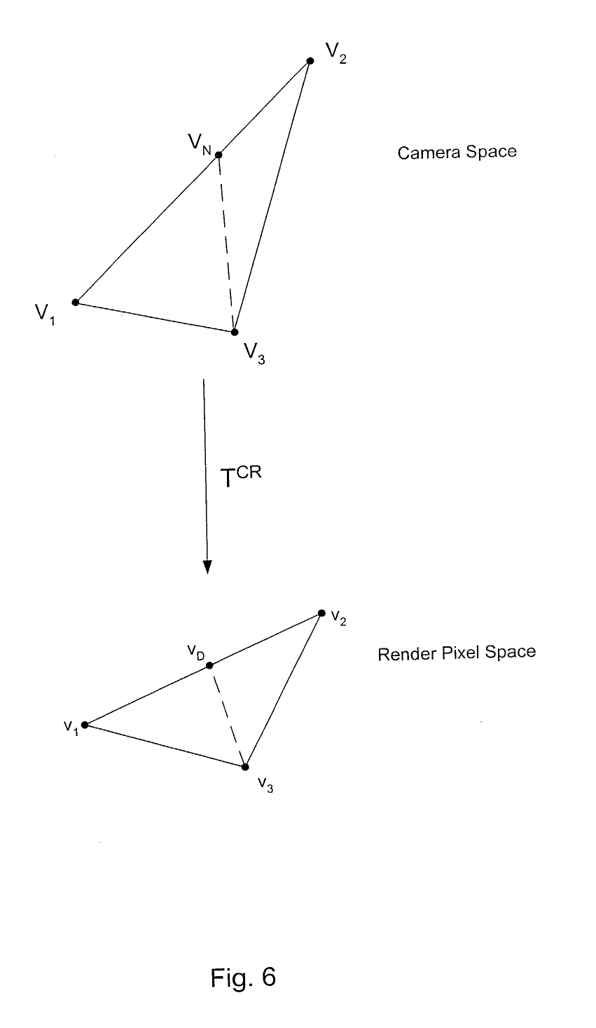

The tessellation process may involve computations both in camera space and render pixel space as suggested by FIG. 6. A triangle in camera space defined by the vertices V₁, V₂ and V₃ projects onto a triangle in render pixel space defined by the vertices v₁, v₂ and V₃ respectively, i.e., vₖ=T^{CR}Vₖ for k=1, 2, 3. If a new vertex V_{N} is injected along the edge from V₁ to V₂, two new subtriangles, having as their common edge the line segment from V_{N} to V₃, may be generated.

Because the goal of the tessellation process is to arrive at component pieces which are sufficiently small as seen in render pixel space, the tessellation process may initially specify a scalar value σ^{R} which defines a desired location v_{D} along the screen space edge from v1 to v2 according to the relation v_{D}=(1−σ^{R})*v₁+σ^{R}*v₂. (For example, one of the fragmentation processes may aim at dividing the screen space edge from v1 to v2 at its midpoint. Thus, such a fragmentation process may specify the value σ^{R}=0.5.) Instead of computing v_{D} directly and then applying the inverse mapping (T^{CR})⁻¹ to determine the corresponding camera space point, the scalar value σ^{R} may then be used to compute a scalar value σ^{C} with the property that the projection of the camera space position

V_{N}=(1−σ^{C})*V₁+σ^{C}*V₂

into render pixel space equals (or closely approximates) the screen space point v_{D}. The scalar value σ^{C} may be computed according to the formula:

$${σ}^{C} = ( \frac{1}{{W}_{2} - {W}_{1}} ) ( \frac{1}{\frac{1}{{W}_{1}} + {σ}^{R} \cdot ( \frac{1}{{W}_{2}} - \frac{1}{{W}_{1}} )} - {W}_{1} ) ,$$

where W₁ and W₂ are the W coordinates of camera space vertices V₁ and V₂ respectively. The scalar value σ^{C} may then be used to compute the camera space position V_{N}=(1−σ^{C})*V₁+σ^{C}*V₂ for the new vertex. Note that σ^{C} is not generally equal to σ^{R} since the mapping T^{CR} is generally not linear. (The vertices V₁ and V₂ may have different values for the W coordinate.)

As illustrated above, tessellation includes the injection of new vertices along primitives edges and in the interior of primitives. Data components (such as color, surface normal, texture coordinates, texture coordinate derivatives, transparency, etc.) for new vertices injected along an edge may be interpolated from the corresponding data components associated with the edge endpoints. Data components for new vertices injecting in the interior of a primitive may be interpolated from the corresponding data components associated with the vertices of the primitive.

In step 122, a programmable displacement shader (or a set of programmable displacement shaders) may operate on the vertices of the micropolygons. The processing algorithm(s) implemented by the displacement shader(s) may be programmed by a user. The displacement shader(s) move the vertices in camera space. Thus, the micropolygons may be perturbed into polygons which no longer qualify as micropolygons (because their size as viewed in render pixel space has increased beyond the maximum size constraint). For example, the vertices of a microtriangle which is facing almost “on edge” to the virtual camera may be displaced in camera space so that the resulting triangle has a significantly larger projected area or diameter in render pixel space. Therefore, the polygons resulting from the displacement shading may be fed back to step 120 for tessellation into micropolygons. The new micropolygons generated by tessellation step 120 may be forwarded to step 122 for another wave of displacement shading or to step 125 for surface shading and light shading.

In step 125, a set of programmable surface shaders and/or programmable light source shaders may operate on the vertices of the micropolygons. The processing algorithm performed by each of the surface shaders and light source shaders may be programmed by a user. After any desired programmable surface shading and lighting have been performed on the vertices of the micropolygons, the micropolygons may be forwarded to step 130.

In step 130, a sample fill operation is performed on the micropolygons as suggested by FIG. 7. A sample generator may generate a set of sample positions for each render pixel which has a nonempty intersection with the micropolygon. The sample positions which reside interior to the micropolygon may be identified as such. A sample may then be assigned to each interior sample position in the micropolygon. The contents of a sample may be user defined. Typically, the sample includes a color vector (e.g., an RGB vector) and a depth value (e.g., a z value or a 1/W value).

The algorithm for assigning samples to the interior sample positions may vary from one hardware implementation to the next. For example, according to a “flat fill” algorithm, each interior sample position of the micropolygon may be assigned the color vector and depth value of a selected one of the micropolygon vertices. The selected micropolygon vertex may be the vertex which has the smallest value for the sum x+y, where x and y are the render pixel space coordinates for the vertex. If two vertices have the same value for x+y, then the vertex which has the smaller y coordinate, or alternatively, x coordinate, may be selected. Alternatively, each interior sample position of the micropolygon may be assigned the color vector and depth value of the closest vertex of the micropolygon vertices.

According to an “interpolated fill” algorithm, the color vector and depth value assigned to an interior sample position may be interpolated from the color vectors and depth values already assigned to the vertices of the micropolygon.

According to a “flat color and interpolated z” algorithm, each interior sample position may be assigned a color vector based on the flat fill algorithm and a depth value based on the interpolated fill algorithm.

The samples generated for the interior sample positions are stored into a sample buffer 140. Sample buffer 140 may store samples in a double-buffered fashion (or, more generally, in an multi-buffered fashion where the number N of buffer segments is greater than or equal to two). In step 145, the samples are read from the sample buffer 140 and filtered to generate video pixels.

The rendering pipeline 100 may be configured to render primitives for an Mᵣₚ×Nᵣₚ array of render pixels in render pixel space as suggested by FIG. 8. Each render pixel may be populated with N_{sd} sample positions. The values Mᵣₚ, Nᵣₚ and N_{sd} are user-programmable parameters. The values Mᵣₚ and Nᵣₚ may take any of a wide variety of values, especially those characteristic of common video formats.

The sample density N_{sd} may take any of a variety of values, e.g., values in the range from 1 to 16 inclusive. More generally, the sample density N_{sd} may take values in the interval [1,M_{sd}], where M_{sd} is a positive integer. It may be convenient for M_{sd} to equal a power of two such as 16, 32, 64, etc. However, powers of two are not required.

The storage of samples in the sample buffer 140 may be organized according to memory bins. Each memory bin corresponds to one of the render pixels of the render pixel array, and stores the samples corresponding to the sample positions of that render pixel.

The filtering process may scan through render pixel space in raster fashion generating virtual pixel positions denoted by the small plus markers, and generating a video pixel at each of the virtual pixel positions based on the samples (small circles) in the neighborhood of the virtual pixel position. The virtual pixel positions are also referred to herein as filter centers (or kernel centers) since the video pixels are computed by means of a filtering of samples. The virtual pixel positions form an array with horizontal displacement ΔX between successive virtual pixel positions in a row and vertical displacement ΔY between successive rows. The first virtual pixel position in the first row is controlled by a start position (Xₛₜₐᵣₜ,Yₛₜₐᵣₜ). The horizontal displacement ΔX, vertical displacement ΔY and the start coordinates Xₛₜₐᵣₜ and Yₛₜₐᵣₜ are programmable parameters. Thus, the size of the render pixel array may be different from the size of the video pixel array.

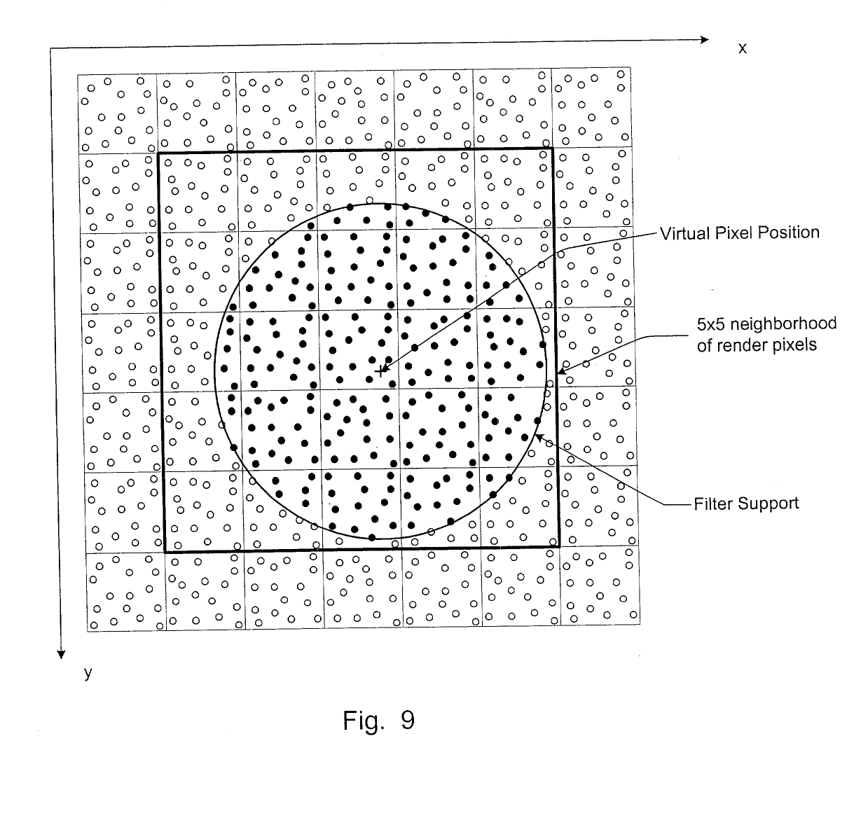

The filtering process may compute a video pixel at a particular virtual pixel position as suggested by FIG. 9. The filtering process may compute the video pixel based on a filtration of the samples falling within a support region centered on (or defined by) the virtual pixel position. Each sample S falling within the support region may be assigned a filter coefficient C_{S} based on the sample's position (or some function of the sample's radial distance) with respect to the virtual pixel position.

Each of the color components of the video pixel may be determined by computing a weighted sum of the corresponding sample color components for the samples falling inside the filter support region. For example, the filtering process may compute an initial red value r_{P} for the video pixel P according to the expression

r_{P}=ΣC_{S}r_{S},

where the summation ranges over each sample S in the filter support region, and where r_{S} is the red color component of the sample S. In other words, the filtering process may multiply the red component of each sample S in the filter support region by the corresponding filter coefficient C_{S}, and add up the products. Similar weighted summations may be performed to determine an initial green value g_{P}, an initial blue value b_{P}, and optionally, an initial alpha value α_{P} for the video pixel P based on the corresponding components of the samples.

Furthermore, the filtering process may compute a normalization value E by adding up the filter coefficients C_{S} for the samples S in the filter support region, i.e.,

E=ΣC_{S}.

The initial pixel values may then be multiplied by the reciprocal of E (or equivalently, divided by E) to determine normalized pixel values:

R_{P}=(1/E)*r_{P}

G_{P}=(1/E)*g_{P}

B_{P}=(1/E)*b_{P}

A_{P}=(1/E)*α_{P}.

The filter coefficient C_{S} for each sample S in the filter support region may be determined by a table lookup. For example, a radially symmetric filter may be realized by a filter coefficient table, which is addressed by a function of a sample's radial distance with respect to the virtual pixel center. The filter support for a radially symmetric filter may be a circular disk as suggested by the example of FIG. 9. The support of a filter is the region in render pixel space on which the filter is defined. The terms “filter” and “kernel” are used as synonyms herein. Let R_{f} denote the radius of the circular support disk.

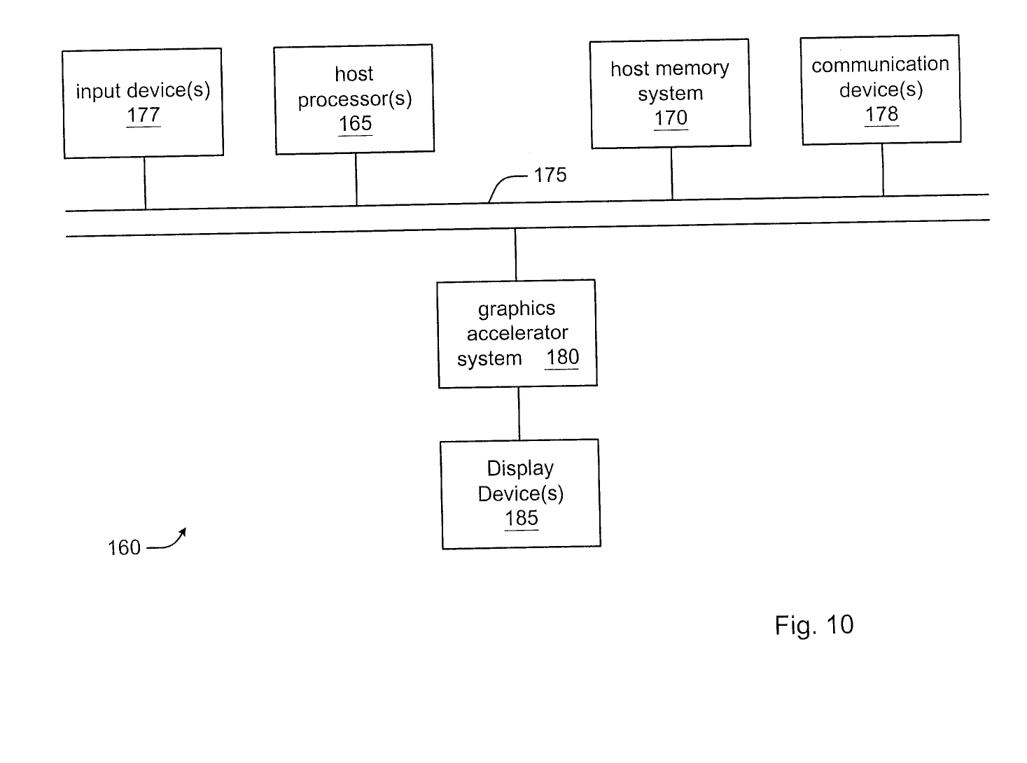

FIG. 10 illustrates one set of embodiments of a computational system 160 operable to perform graphics rendering computations. Computational system 160 includes a set of one or more host processors 165, a host memory system 170, a set of one or more input devices 177, a graphics accelerator system 180 (also referred to herein as a graphics accelerator), and a set of one or more display devices 185. Host processor(s) 165 may couple to the host memory system 170 and graphics system 180 through a communication medium such as communication bus 175, or perhaps, through a computer network.

Host memory system 170 may include any desired set of memory devices, e.g., devices such as semiconductor RAM and/or ROM, CD-ROM drives, magnetic disk drives, magnetic tape drives, bubble memory, etc. Input device(s) 177 include any of a variety of devices for supplying user input, i.e., devices such as a keyboard, mouse, track ball, head position and/or orientation sensors, eye orientation sensors, data glove, light pen, joystick, game control console, etc. Computational system 160 may also include a set of one or more communication devices 178. For example, communication device(s) 178 may include a network interface card for communication with a computer network.

Graphics accelerator system 180 may be configured to implement the graphics computations associated with rendering pipeline 100. Graphics accelerator system 180 generates a set of one or more video signals (and/or digital video streams) in response to graphics data received from the host processor(s) 165 and/or the host memory system 170. The video signals (and/or digital video streams) are supplied as outputs for the display device(s) 185.

In one embodiment, the host processor(s) 165 and host memory system 170 may reside on the motherboard of a server computer (or personal computer or multiprocessor workstation, etc.). Graphics accelerator system 180 may be configured for coupling to the motherboard.

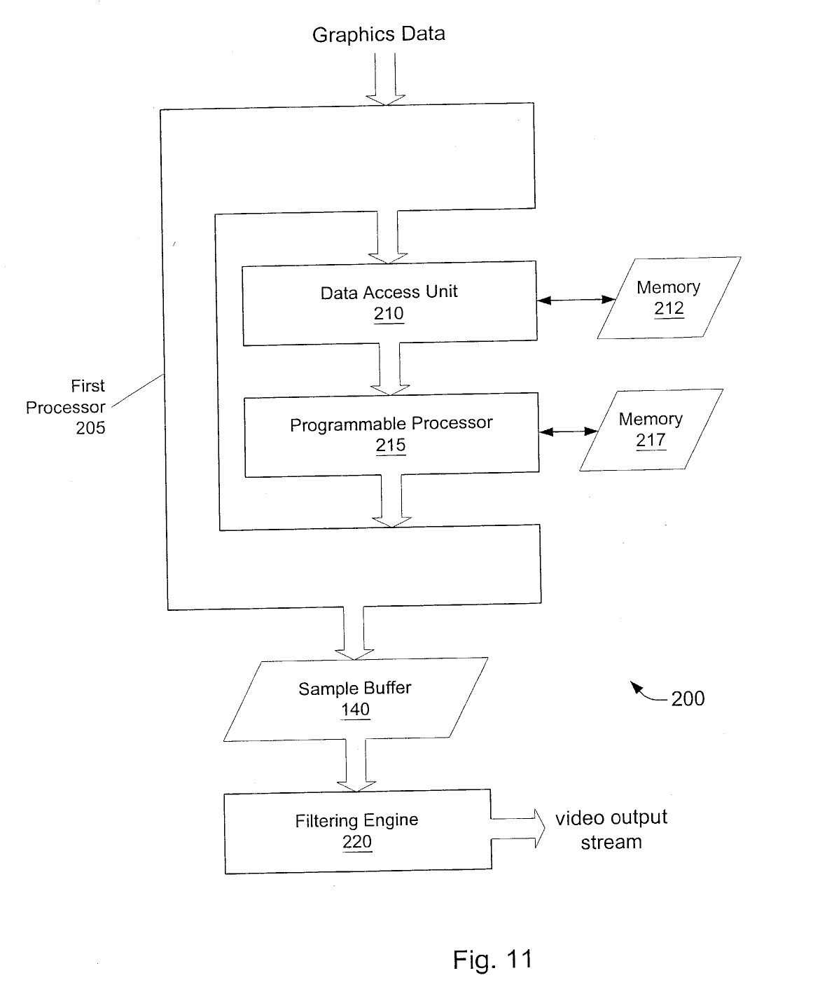

The rendering pipeline 100 may be implemented in hardware in a wide variety of ways. For example, FIG. 11 illustrates one embodiment of a graphics system 200 which implements the rendering pipeline 100. Graphics system 200 includes a first processor 205, a data access unit 210, programmable processor 215, sample buffer 140 and filtering engine 220. The first processor 205 may implement steps 110, 112, 115, 120 and 130 of the rendering pipeline 100. Thus, the first processor 205 may receive a stream of graphics data from a graphics processor, pass micropolygons to data access unit 210, receive shaded micropolygons from the programmable processor 215, and transfer samples to sample buffer 140. In one set of embodiments, graphics system 200 may serve as graphics accelerator system 180 in computational system 160.

The programmable processor 215 implements steps 122 and 125, i.e., performs programmable displacement shading, programmable surface shading and programmable light source shading. The programmable shaders may be stored in memory 217. A host computer (coupled to the graphics system 200) may download the programmable shaders to memory 217. Memory 217 may also store data structures and/or parameters which are used and/or accessed by the programmable shaders. The programmable processor 215 may include one or more microprocessor units which are configured to execute arbitrary code stored in memory 217.

Data access unit 210 may be optimized to access data values from memory 212 and to perform filtering operations (such as linear, bilinear, trilinear, cubic or bicubic filtering) on the data values. Memory 212 may be used to store map information such as bump maps, displacement maps, surface texture maps, shadow maps, environment maps, etc. Data access unit 210 may provide filtered and/or unfiltered data values (from memory 212) to programmable processor 215 to support the programmable shading of micropolygon vertices in the programmable processor 215.

Data access unit 210 may include circuitry to perform texture transformations. Data access unit 210 may perform a texture transformation on the texture coordinates associated with a micropolygon vertex. Furthermore, data access unit 210 may include circuitry to estimate a mip map level λ from texture coordinate derivative information. The result of the texture transformation and the MML estimation may be used to compute a set of access addresses in memory 212. Data access unit 210 may read the data values corresponding to the access addresses from memory 212, and filter the data values to determine a filtered value for the micropolygon vertex. The filtered value may be bundled with the micropolygon vertex and forwarded to programmable processor 215. Thus, the programmable shaders may use filtered map information to operate on vertex positions, normals and/or colors, if the user so desires.

Filtering engine 220 implements step 145 of the rendering pipeline 100. In other words, filtering engine 220 reads samples from sample buffer 140 and filters the samples to generate video pixels. The video pixels may be supplied to a video output port in order to drive a display device such as a monitor, a projector or a head-mounted display.

Shading Language Compiler

In one set of embodiments, a new high-level shading language may be defined and implemented by a shading language compiler. The compiler may operate on user-created shader functions (written in the shading language) to generate object code for a target processor. The compiler may receive directives that control the compilation process. In particular, the compiler may receive specialization directives that control the generation of specialized versions of the shader functions. In alternative embodiments, the methodologies described herein may be implemented as an extension to an existing shading language.

A shader function (also referred to herein more succinctly as a shader) has a set of input variables X₁, X₂, X₃, . . . , X_{N}, where N is a positive integer. Each input variable X_{J} has a corresponding space P_{J} in which it may take values. The input variables may conform to any of a wide variety of standard or user-defined data types. For example, the input variables may be byte, word, integer, fixed point, floating point, Boolean or set variables, or any combination thereof. (Set variables are variables that behave like mathematical sets. Set variables may be internally represented as bit vectors as has been done in support of sets in previous computer languages.)

The Cartesian product P₁×P₂× . . . ×P_{N} of the spaces P₁, P₂, . . . , P_{N} is referred to herein as the shader space. A programmer may define subsets S₁, S₂, . . . , S_{M} of the shader space by specifying corresponding constraints C₁, C₂, . . . , C_{M} on one or more of the input variables or combinations of the input variables. The number M of subsets is a positive integer. The programmer may embed the constraints in an input file (e.g., in the same input file containing the shader code, or perhaps, in a separate input file specified by the user) as directives to the compiler. The compiler may execute on a host computer (e.g., one of host processors 165 of FIG. 10).

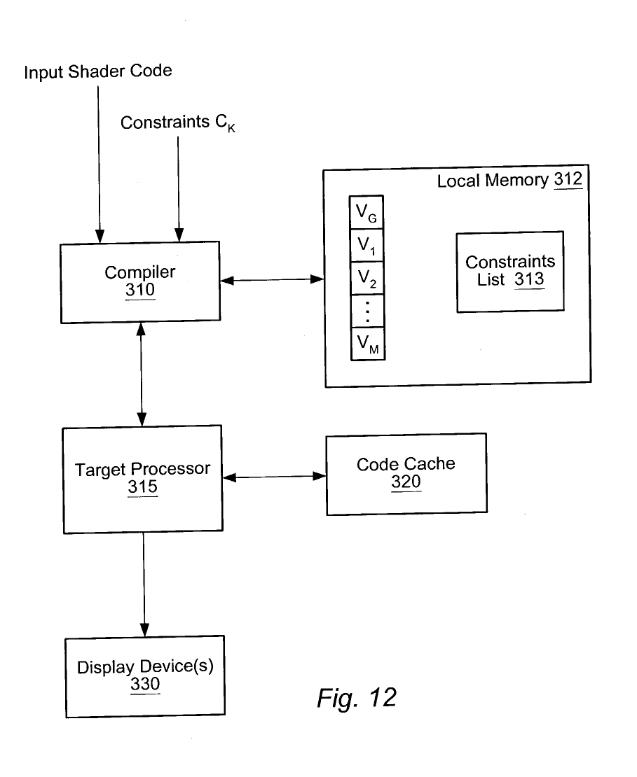

At compile time, the compiler may receive the input shader code and the subset-defining constraints from the input file (or, more generally, from any desired input interface) as suggested by FIG. 12. The compiler 310 may compile the input shader code to obtain a generic version V_{G} and store the generic version V_{G} in a local memory 312 (e.g., in a portion of host system memory 170). Furthermore, for each subset-defining constraint C_{K}, the compiler 310 may compile a specialized (e.g., optimized) version V_{K} of the input shader code based on the subset-defining constraint C_{K}. Thus, the constraints C_{K} may be referred to herein as code specialization constraints.

The specialized version V_{K} may be more compact and efficient than the generic version V_{G} due to optimizations such as constants folding and excision of code blocks which are not used under the constraint C_{K}. The compiler 310 stores the specialized version V_{K} in the local memory 312 and stores the constraint C_{K} on a constraint list 313. The constraint list 313 may also be stored in the local memory. FIG. 12 illustrates one embodiment of a graphical computing system configured to perform programmable shading of graphical objects.

Constants folding includes operations such as replacing an expression involving one or more variables with a simplified expression based on knowledge of particular values of some subset of the one or more variables. For example, the expression X+Y may be replaced with X if Y==0. Other examples include:

X+Y→0 if X==0 && Y==0,

X*Y→0 if Y==0,

X*Y→X if Y==1,

$$A ? B \text{:} C -> \{ \begin{matrix}B if A == T \\ C otherwise\end{matrix} \} ,$$

where X, Y, A, B and C represent expressions. For example, X, Y, A, B and C may represent simple expressions such as constants or variable identifiers, or complex expressions containing subexpressions. In the later case, expression simplification rules such as those listed above are applied recursively to simplify the original complex expression as much as possible. The notation “U→V” is to be read “U simplifies to V”. As used herein, T and F occurring in Boolean expressions denote TRUE and FALSE respectively. The symbol “&&” denotes the logical AND operator.

At run-time, a calling program calls the shader with particular values of the input variables X₁, X₂, . . . , X_{N}. The particular values of the input variables may be interpreted as a point (X₁, X₂, . . . , X_{N}) in the shader space. A run-time agent of the compiler may search the constraint list 313 to determine if the current input point (X₁, X₂, . . . , X_{N}) satisfies any of the constraints C_{K} on the constraint list. If the current input point (X₁, X₂, . . . , X_{N}) satisfies one of the constraints C_{K}, the run-time agent may invoke execution of the specialized version V_{K} of the shader code by a programmable target processor 315. (The target processor may reside in a graphics accelerator such as graphics accelerator system 180.) This may involve transferring (or commanding the transfer) of the specialized version V_{K} from the local memory 312 to the target processor 315.

The target processor may execute the specialized version V_{K} once for each vertex in a stream of vertices (e.g., the vertices of micropolygons associated with a particular object), and thus, generate shaded vertices. In one embodiment, the target processor is the programmable processor 215 of FIG. 11. The programmable processor 215 may forward the shaded vertices to the first processor 205. The first processor 205 may operate on the shaded vertices as described above to generate samples for render pixels. The samples may be stored in sample buffer 140, and then, subsequently filtered by filtering engine 220 to generate video output pixels. The video output pixels may be used to drive one or more display devices 330.

The following pseudo-code illustrates one set of embodiments of a method for increasing the execution efficiency of a graphical computing system.

```
Compile Time: Compile generic shader;
    Compile preselected optimized versions;
    Store in local memory;
Run Time: For each object (in an collection of objects) {
      Select shader parameters;
    For each stored version in local memory {
      Compare shader parameters;
      If match, invoke execution of matching optimized compiled
      version;
      If no match, invoke execution of generic compiled version, or,
      immediately compile a version corresponding to selected shader
      parameters and invoke execution of this immediately compiled
      version. }}
```

In various embodiments, the compiler supports the compilation of a set of shader programs contained within one or more input files. The compiler may combine information from different types of shaders (e.g., surface shaders and light shaders) in order to generate the specialized compiled versions.

It is desirable that the syntax for specifying the constraints to the compiler be simple and efficient. For example, suppose that N=4, and X₁, X₂, X₃ and X₄ are Boolean variables. A statement such as

SPECIALIZE SHADERNAME(T,*,F,*)

may specify the constraint

(X₁==T) && (X₃==F),

where SHADERNAME is the name of the shader. The “*” symbol in the second and fourth positions may indicate that the corresponding variables are unspecified. The “&&” symbol denotes the logical AND operator.

Under the assumption that N=7, X₁ is a Boolean variable, X₂ is a floating point variable, and X₃ and X₄ are integer variables, a statement such as

SPECIALIZE SHADERNAME(T, [b,c], 61, +, *)

may specify the constraint

(X₁==T) && (X₂∈[b,c]) && (X₃==61) && (X₄>0),

where [b,c] denotes the closed interval from b to c. (Open and half open intervals may also be used to define floating-point ranges.) The “*” at the end of the variable list indicates the remaining variables are unspecified. Furthermore, a statement such as

SPECIALIZE SHADERNAME(*, −, {2, 5, 7}, !d, *)

may specify the constraint

(X₂<0) && (X₃∈{2,5,7}) && (X₄!=d).

The expression “U∈A” means “U is an element of the set A”. In various other embodiments, any of various other symbols or character strings may be used in place of the lower case Greek epsilon to denote the “is an element of” operator. The notation “!=” represents the inequality operator (i.e., the “not equal to” operator). A statement such as

SPECIALIZE SHADERNAME(*, >3.0, !{3, 5, 9}, 0, *)

may specify the constraint

(X₂>3.0) && (X₃∉{3,5,9}) && (X₄==0).

In addition to the “>” inequality, the compiler may support the “<”, “<=” and “>=” inequalities.

In some embodiments, the compiler may provide support for the definition of constraints such as

(Xⱼ>Xₖ),

f(Xⱼ)>0,

g(Xⱼ,Xₖ)>0,

or combinations thereof, where f(Xⱼ) is an arbitrary function of variable Xⱼ, and g(Xⱼ,Xₖ) is an arbitrary function (e.g., a linear function) of the two variables Xⱼ and Xₖ. Functions of more than two variables are also contemplated.

Each of the statements illustrated above imply the entering of some data for each of the N input variables. If N is large, entering such statements may become a burden to the user especially if the user desires only to specify a few of the input variables. Furthermore, if a user desires to add one or more variables to the list of shader input variables, it may be burdensome to update such statements. Thus, the compiler may support statements of the form:

SPECIALIZE SHADERNAME(X_{J1}=C₁, X_{J2}=C₂, . . . , X_{JP}=C_{P}),

where X_{J1}, X_{J2}, . . . , X_{JP} represents a subset of the N input variables, and C₁, C₂, . . . , C_{P} are constants or sets of constants. The number P of input variables in the subset is greater than or equal to one, and, less than or equal to N. For example, if the user desires to specify only one input variable, a statement of the following form may be used:

SPECIALIZE SHADERNAME(X_{J1}=C₁),

where J₁ is equal an integer in the range 1 to N inclusive.

The programmer may specify constraints that correspond to input value combinations that have a high probability of occurrence at run-time. For example, in the N=4 Boolean variable case, the programmer may anticipate that the Boolean vectors (T,T,T,F), (T,F,F,F) and (F,T,T,F) will occur frequently during execution phase. Thus, the programmer may supply the directives

SPECIALIZE SHADERNAME(T,T,T,F),

SPECIALIZE SHADERNAME(T,F,F,F),

SPECIALIZE SHADERNAME(F,T,T,F),

and thus, may induce the generation of three corresponding specialized versions of the shader.

It is noted that shaders may use Boolean input variables to turn on or off various shader features, e.g., features such as bump mapping, displacement mapping, lighting and shadowing of various kinds, texturing of various kinds, etc. The execution of sections of code within the shader may be conditioned on the values of the Boolean variables. Thus, sections of the shader code may be selectively included or excluded from a specialized compiled version based on specified values of the Boolean input variables in a given constraint. For example, suppose that the shader has the following structure:

SHADERNAME (Bool doBump, Bool doShadow, Bool doBaseTexture)

if (doBump) [... bump mapping code ...]
else [... bump else code ...];
if (doShadow) [... shadow mapping code ...];
if (doBaseTexture) [... base texture code ...];
return;

If the programmer specifies the constraint (F, F, T), the compiler generates a specialized version that retains the bump else code and base texture code and is missing the bump mapping code and shadow mapping code.

More generally, suppose that a shader has N Boolean input parameters. Given a Boolean constraint vector (A₁, A₂, . . . , A_{N}), where each A₁ equals one of T, F or “*” (i.e., unspecified), the compiler may generate a specialized version of the shader based on the Boolean parameters which have been specified. For example, if the programmer specifies the constraint (*, F, T) for the shader given above, the compiler generates a specialized version that retains the “if-then-else” block containing the bump mapping code and the bump else code, retains the base texture code, and omits the shadow mapping code.

In some embodiments, the compiler may support the use of sets as a data type. For example, a type FRUIT may be declared with the statement

Type FRUIT {apple, banana, blueberry, coconut, pineapple, watermelon, raspberry, strawberry},

where { . . . } denotes a list of allowable values of variables having the type FRUIT. A set variable such as TROPICAL may be declared with the statement

TROPICAL=FRUIT Set.

Thus, TROPICAL is constituted as a set whose elements are allowed to be of type FRUIT. The set TROPICAL may be assigned members with a statement such as

TROPICAL={banana, coconut, pineapple}.

Similarly, a set BERRY may be declared and assigned members with statements such as

BERRY=FRUIT Set;

BERRY={blueberry, raspberry, strawberry}.

A shader may have an input variable X of type FRUIT. The execution of code sections within the shader may be conditioned on the value of the variable X. For example, suppose that a shader has the following structure:

```
SHADERNAME (X)
  if (X ∈ {apple, watermelon}) {
    common apple-watermelon code;
    if (X==apple) [... apple code ...];
    if (X==watermelon [... watermelon code ...]
  if (X == banana) [... banana code ...];
  if (X == blueberry) [...blueberry code ...];
  if (X == coconut) [...coconut code ...];
  if (X == pineapple) [...pineapple code ...];
  if (X == raspberry) [...raspberry code ...];
  if (X == strawberry) [...strawberry code ...];
  if (X ∈ TROPICAL) [... tropical code ...];
  if (X ∈ BERRY) [... berry code ...];
  return;
```

Note that there is typically a set of reserved variable names to which the results of shader computations may be assigned within the body of the shader.

In response to the compiler directives

SPECIALIZE SHADERNAME(TROPICAL)

SPECIALIZE SHADERNAME(raspberry)

SPECIALIZE SHADERNAME ({apple, pineapple})

the compiler may generate three specialized versions of the shader. The TROPICAL version may retain the code sections that get used in the cases X∈TROPICAL (i.e., banana code, coconut code, pineapple code, and tropical code) and omit the other code sections. The raspberry version may retain the code section (or sections) that get used when X equals raspberry (i.e., raspberry code and berry code) and omit the other code sections. The third version may retain the code sections that get used in the cases X equals apple and X equals pineapple (i.e., common apple-watermelon code, apple code, pineapple code and tropical code) and omit the other code sections.

In general, the compiler may provide support for compiler directives such as

SPECIALIZE SHADERNAME (SET)

SPECIALIZE SHADERNAME ({a, b, c, . . . })

SPECIALIZE SHADERNAME (ELEMENT)

The first directive induces the compiler to create a specialized version that retains any code section that is executed in any of the cases X∈SET, where SET is a predefined set. The second directive induces the compiler to create a specialized version that retains any code section that is executed in the any of the explicitly enumerated cases X=a, b, c, . . . . The third directive induces the compiler to create a specialized version that retains any code section that is executed in the case X=ELEMENT.

In response to the compiler directive

SPECIALIZE SHADERNAME(@)

the compiler may generate one specialized version of the shader for each possible value of the variable X (e.g., for X each possible value of the Type FRUIT). In response to the compiler directive

SPECIALIZE SHADERNAME(@A)

the compiler may generate one specialized version of the shader for each possible value of the variable X in the set A.

Within the shader code, set variables or element variables (such as X in the examples above) may be used as part of conditional expressions that give a Boolean (T or F) result. The conditional expression may be used to determine the execution of operations or code segments within the shader. Thus, a constraint imposed on an input variable may allow the shader to be specialized (or optimized). Conditional expressions include expressions of the form X∈A, X∉A, X==e, Y==B, Y!=B and Y⊂C, where A, B and C are sets, and e is an element of a set. Such conditional expressions may be included in any of a variety of statements or other expressions such as

```
R = (conditional expression) ? U:V;
If (conditional expression) THEN ...;
If (conditional expression) THEN ... ELSE ...;
SWITCH (X) {
  CASE (C₁): ...
  CASE (C₂): ...
  ...
  CASE (C_{Q}): ... };
```

The SWITCH example above implicitly contains tests of the form X==C_{J}, J=1, 2, . . . , Q. Where C₁, C₂, . . . , C_{Q} are elements of a set.

As described above, each compiler directive specifies a constraint C_{K} on one or more of the input variables, and thus, a corresponding subset S_{K} of the shader space. Note that each constraint C_{K} may represent a logical combination (e.g., a logical AND combination) of component constraints as suggested by various examples above.

In some embodiments, the target processor may maintain its own code cache for shader code versions. (For example, a portion of memory 217 in graphics accelerator system 180 may be allocated to store shader code versions.) After having determined that the current input point (X₁, X₂, . . . , X_{N}) matches the constraint C_{K}, the run-time agent of the compiler may determine if a copy of version V_{K} already resides in the code cache of the target processor. If so, the run-time agent may command the target processor to access the version V_{K} from its own code cache. Thus, the code transfer from local memory to the target processor may be avoided when it is not necessary. In these embodiments, the run-time agent maintains a table that indicates which shader versions are resident in the code cache of the target processor.

If the run-time agent determines that the current input point (X₁, X₂, . . . , X_{N}) satisfies none of the constraints C_{K} stored in the constraint list, the run-time agent may:

(a) compile a specialized version V_{X} of the shader code based on the current input point X=(X₁, X₂, . . . , X_{N}), and forward the specialized version V_{X} to the target processor; or

(b) command the transfer of the generic version V_{G} of the shader code from the local memory to the target processor.

A user/programmer may supply a control parameter input to the compiler to determine which option (a) or (b) is implemented. When operating in mode (b), the run-time agent may determine if the generic version V_{G} already resides in the code cache of the target processor. If so, the run-time agent may send the current input point X to the target processor along with a command instructing the target processor to access and execute the generic version V_{G} from the code cache.

In some embodiments, two or more of the subsets S₁, S₂, . . . , S_{M} defined by the corresponding constraints C₁, C₂, . . . , C_{M} may have non-empty intersections. Thus, it is possible for the current input point (X₁, X₂, . . . , X_{N}) to reside in two or more of the subsets, i.e., to satisfy two or more of the constraints. If the current input point (X₁, X₂, . . . , X_{N}) satisfies two or more of the constraints C₁, C₂, . . . , C_{M}, the run-time agent may select the version V_{Kmin} which has the most efficient code from among those versions which correspond to the two or more satisfied constraints. The compiler may transfer the version V_{Kmin} to the target processor (if it is not already resident in the code cache of the target processor). To support these embodiments, the compiler may store an estimate of execution efficiency (or execution time) for each of the stored specialized versions V₁, V₂, . . . , V_{M}. In one embodiment, the compiler may request and receive reports of the execution time (or estimated execution time) of versions V_{K} from the target processor. For example, in one embodiment, programmable processor 215 may serve as the target processor. Programmable processor 215 may be configured to execute shader versions stored in memory 217, to measure (or estimate) the execution time of the shader versions, and to report the execution time to the run-time agent (executing on the host computer).

In a large number of invocations of the shader by a given application program (or set of application programs), the input point X may be observed to repeatedly visit certain regions within the shader space instead of being uniformly distributed. Thus, a user/programmer may select the number M and the constraints C₁, C₂, . . . , C_{M} so that the respective subsets S₁, S₂, . . . , S_{M} correspond to or cover (or cover some portion of) the frequently visited regions. For example, the user may observe that the Boolean input vector (X₁, X₂, X₃, X₄) repeatedly visits the combinations (T, T, T, T), (T, T, T, F) and (T, T, F, F). Thus, three constraints corresponding to these combinations may be specified.

In some embodiments, the compiler may be configured to compile statistics during a graphics session, and report to the user the regions of shader space most frequently visited, and/or, to recommend constraints that effectively cover those regions. For example, the compiler may build a histogram for each input variable or for selected subsets of the input variables or combinations of the input variables, and report the histogram(s) to the user/programmer after completion of the graphics session or in response to a user request.

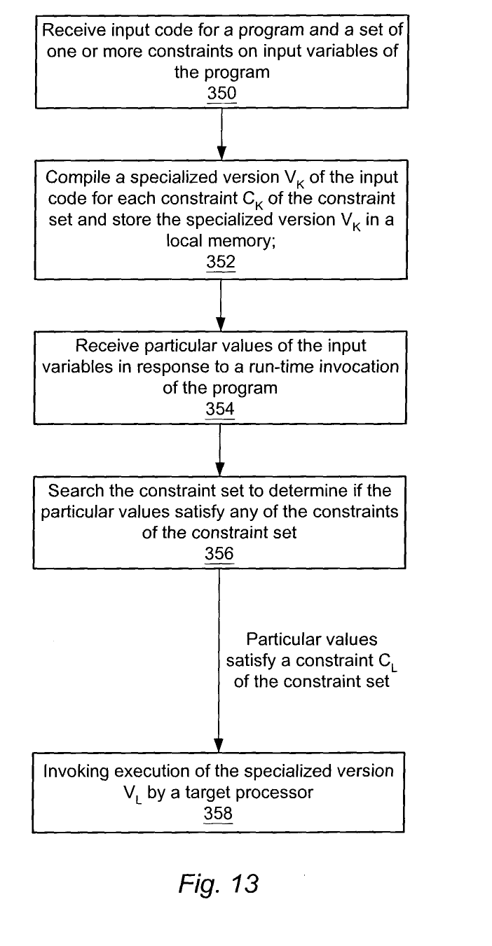

In one set of embodiments, a method for implementing a compiler may involve the steps outlined in FIG. 13. The method may comprise:

(a) receiving input code for a program and a set of one or more constraints on input variables of the program as suggested by step 350;

(b) compiling a specialized version V_{K} of the input code for each constraint C_{K} of the constraint set (i.e., the set of one or more constraints) and storing the specialized version V_{K} in a local memory as suggested by step 352;

(c) receiving particular values of the input variables in response to a run-time invocation of the program as suggested by step 354;

(d) searching the constraint set to determine if the particular values satisfy any of the constraints of the constraint set as suggested by step 356; and

(e) in response to determining that the particular values satisfy a constraint C_{L} of the constraint set, invoking execution of the corresponding specialized version V_{L} by a target processor as suggested by step 358.

The step of invoking execution of the specialized version V_{L} may involve transferring the specialized version V_{L} from the local memory to the target processor. The target processor may execute the specialized version V_{L} for each vertex in a set of vertices in a first space. In various embodiments, the first space may be camera space, virtual world space or model space. The vertices may be vertices of micropolygons (e.g., trimmed pixels) generated by one or more tessellation processes.

In some embodiments, the target processor has read and write access to a code cache. (For example, in one embodiment, the target processor and code cache are included in a graphics accelerator such as graphics accelerator system 180.) Thus, the step of invoking execution of the specialized version V_{L} may include determining if the code cache contains a copy of the specialized version V_{L}, and transferring the specialized version V_{L} from the local memory to the target processor (or code cache) only if the code cache does not contain a copy of the specialized version V_{L}. If the code cache does contain a copy of the specialized version V_{L}, said invoking of execution may involve sending a command instructing the target processor to access the specialized version V_{L} from the code cache. Thus the code transfer is avoided when it is not necessary.

The method may further include compiling the input code to generate a generic version V_{G} of the input code and storing the generic version V_{G} in the local memory. If the searching step (d) determines that the particular values match none of the constraints of the constraint set, the generic version V_{G} may be transferred from the local memory to the target processor (if it does not already reside in the code cache of the target processor).

Alternatively, instead of invoking execution of the generic version V_{G} in the case where the particular values satisfy none of the constraints of the constraint set, the method may involve compiling a specialized version V_{X} corresponding to the particular values of the input variables and transferring the specialized version V_{X} to the target processor.

In one embodiment, the method may involve determining if the particular values satisfy two or more constraints of the constraint set. If so, the compiler may conditionally transfer (from the local memory) to the target processor a specialized version V_{Kmin} having a smallest estimated execution time from among the specialized versions corresponding to the two or more constraints which have been satisfied. As noted above, the transfer may be conditioned upon a determination that the code cache of the target processor does not already contain the specialized version V_{K} in.

Each of the constraints in the constraint set may specify a logical combination of one or more component constraints. Each of the component constraints may operate on one or more of the input variables. (See the various examples given above.) The input code may be written in a high-level programming language.

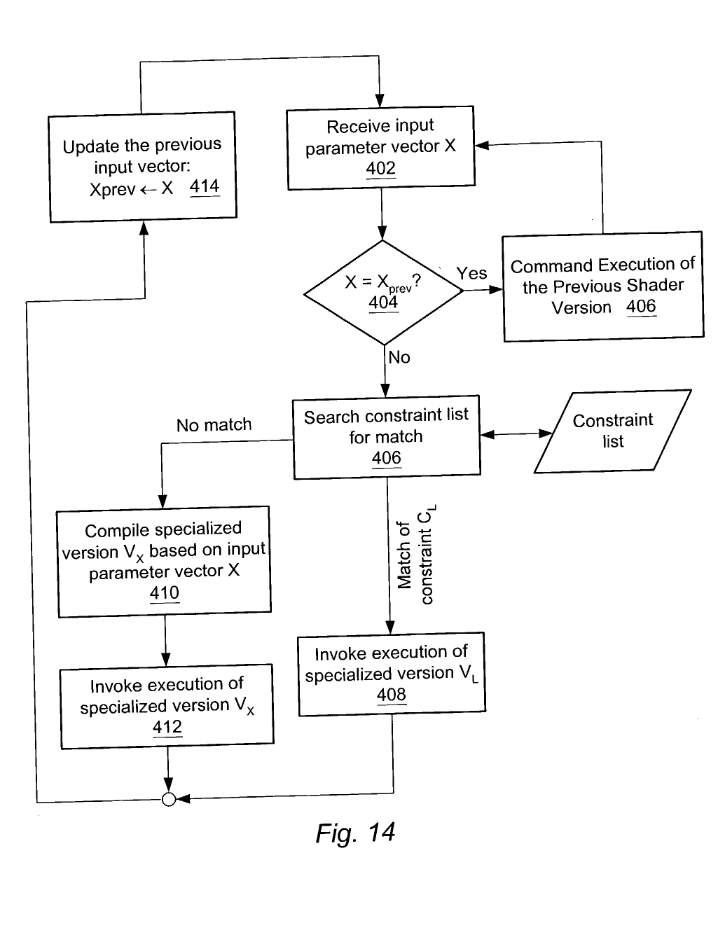

In one embodiment, a method for handling shader requests at shader execution time may include the following steps as illustrated in FIG. 14. In step 402, the compiler may receive an input parameter vector X corresponding to a request for the execution of the shader program asserted by a calling process. In step 404, the compiler may compare the input parameter vector X to a previous parameter vector X_{Prev} corresponding to a previous invocation of the shader program.

If the input parameter vector X equals the previous parameter vector X_{Prev}, the compiler will have already downloaded a shader version corresponding to vector X to the target processor (e.g., to the code cache of the target processor) in response to a previous request for execution of the shader. Thus, the compiler may simply send a command instructing the target processor to execute the previously downloaded shader version (step 406), and then, return to step 402 to wait for the next instance of the shader program. If the input parameter vector X does not equal the previous parameter vector, step 406 may be performed.

In step 406, the compiler may search the constraint list to determine if the input parameter vector X matches any of the constraints of the constraint list. If the input parameter vector X matches a constraint C_{L} of the constraint list, the compiler may perform step 408. If the input parameter vector X matches none of the constraints of the constraint list, the compiler may perform step 410.

In step 408, the compiler may invoke execution of the specialized version V_{L} corresponding to the matched constraint C_{L} as variously described above. Then the compiler may update the previous parameter vector (step 414) and return to step 402 to await the next invocation the shader program.

In step 410, the compiler may compile a specialized version V_{X} of the shader program based on the input parameter vector X. In step 412, the compiler may invoke execution of the specialized version V_{X}, e.g., by transferring the specialized version V_{X} to the target processor. Then the compiler may update the previous parameter vector (step 414) and return to step 402 to await the next invocation the shader program.

In one set of embodiments, a method for handling shader requests in a graphics environment may be implemented as follows. The method involves:

(a) storing in a host memory a shader program that has N Boolean input parameters, where the shader program comprises a plurality of code sections, where N is greater than or equal to two, where each of the Boolean input parameters controls the execution of a corresponding code section of the shader program;

(b) receiving a set of specialization vectors, where each specialization vector specifies a particular selection among the 2^{N} possible states for the N Boolean input parameters;

(c) compiling a specialized version of the shader program for each of the specialization vectors in the vector set;

(d) storing the specialized versions in the host memory;

(e) receiving a request for the execution of the shader program, where the request includes an input vector specifying values of the N Boolean input parameters;

(f) performing a comparison operation to determine if the input vector equals any of the specialization vectors in the vector set; and

(g) invoking the execution of one of the specialized versions on a programmable processor in a graphics accelerator system in response to said comparison operation identifying a matching vector in the vector set.

Step (g), i.e., said invoking of execution, may include downloading said one of the specialized versions from the host memory to a program memory (e.g., a code cache) in the graphics accelerator. The program memory is accessible by the programmable processor. Alternatively, said invoking of execution may include sending a command instructing the programmable processor to access and execute said one of the specialized versions from the program memory.

Let g₁, g₂, . . . , g_{M} denote the specialization vectors of the vector set. Each specialization vector g_{K} includes particular values for each of the N Boolean input variables. Let V_{K} denote the specialized compiled version of the program corresponding to specialization vector g_{K}. In one embodiment, the components of specialization vector g_{K} may control whether corresponding code sections of the shader program get incorporated into the specialized version V_{K}.

In one set of embodiments, a feature of the shader language which enables ahead-of-time specialization is the use of set types. Input variables may be declared to belong to a set type. The set type may be declared in a separate file or other compilation unit. At compilation time, a series of subsets may be specified, allowing specialized versions of the code to be generated for all combinations of values of the input variables, subject to the constraints given by the subset specifications. Boolean variables are a special case of set variables.

Variables that take on continuous or discrete numeric values may be specified to lie within a range for the purposes of ahead-of-time compilation. This information may allow loops to be better optimized, or for various run-time range checks to be avoided.

At user run-time, i.e., when a frame is to be rendered, the current settings are examined and the set of precompiled shaders is examined for a match. This process could be made more efficient by using a variety of database-style techniques, as it amounts to a Boolean “AND” query. If a match is found, the matching precompiled shader may be used, possibly after a final optimization pass in which the remaining non-varying parameters are evaluated and constants folding is performed. If no match is found, either (1) compilation can be performed, or (2) a more generic (and thus less efficient) compiled version of the shader may be used.

In some embodiments, a programmable shading language may be configured to support controlled partial evaluation based on various sources of information and at various times. Given a shader as input, the compiler for the shading language may:

(a) generate a specialized code version for each point in the shader space, i.e., for each combination of values of the shader input variables;

(b) generate a specialized code version for each of one or more subsets of the shader space, wherein each subset of the shader space is defined by a corresponding constraint on one or more of the input variables;

(c) generate a completely generic code version of the shader by compiling without specialization.

Thus, the specialized versions may occur anywhere along a continuum of generality from completely generic (corresponding to the empty constraint) to atomic (corresponding to a single point of the shader space, i.e., a specification of all the input variables). Between the two extremes are partially generic versions. A partially generic version is generated in response to a constraint C_{K} that defines a subset of shader space that includes more than a point but less than the whole space, e.g., a constraint that specifies one or more but less than all of the N input variables.

Option (a) is referred to as brute force specialization. Brute force specialization may consume large amounts of memory if N is large and/or the number of states attainable by the input variables is large. Thus, when instructed to perform brute force specialization, the compiler may determine the number N_{BF} of specialized versions that would be generated by a brute force specialization, and compare the number N_{BF} to a specialization threshold. The number N_{BF} may be an input to the compiler.

If the number N_{BF} is less than or equal to the specialization threshold, the compiler may perform the brute force specialization. If the number N_{BF} is greater than the specialization threshold, the compiler may generate only a subset of the set of N_{BF} versions based on one or more heuristics. For example, the subset may be selected based on user-specified (or programmer specified) indications of the relative importance of certain input variables or groups of input variables.

In option (b), the input variable constraints may be user specified (e.g., by means of compiler directives as described variously above) or otherwise specified. For example, a constraint determination agent may collect statistics on the input point X from a set of calls to the shader during run time (e.g., user run time or developer run time) of a graphics application, and analyze the statistics to determine constraints C_{K} so that the corresponding subsets S_{K} of shader space cover the regions that are frequently visited by the input point X. The constraint determination agent may be the compiler, a user of the graphics application, a developer of a graphics application, a developer of a shader or shader library, etc. It is noted that the process of collecting and analyzing statistics to derive constraints and generating specialized versions in response to the derived constraints may be performed repeatedly during run-time of the graphics application.

As another example, the compiler may perform a static analysis of the shader calls in a graphics application at the initiation of run time (i.e., at load time), and derive constraints C_{K} so that the corresponding subsets S_{K} of shader space cover the regions that are indicated by the calls in the application code.

The generation of specialized versions by partial evaluation may be controlled by any combination of:

(1) constraints (or compiler directives) specified by a user, programmer, developer, etc.;

(2) constraints determined from a load-time analysis of input variable values present in shader calls of the application code;

(3) constraints determined from a run-time analysis of the input variable values present in a set of shader calls during run-time (e.g., user run-time or developer run-time, etc.);

(4) constraints determined based on a specification (e.g., a user specification or programmer specification) of the importance or relative importance of input variables or groups of input variables;

(5) input parameter values present in a specific shader call (e.g., as suggested by step 410 of FIG. 14.

The generation of specialized versions by partial evaluation may be performed at various times such as:

(A) at the initialization of user run-time, i.e., a user load-time;

(B) during user run-time;

(C) prior to user load-time such as: at time of development or production of a graphics application; at time of shader production or development;

etc.

At user load-time, the compiler may have access to more information about the target process than was known at development or manufacturing time. Furthermore, at user run-time, the compiler may be able to dynamically adjust the generation of specialized shader versions in response to dynamically gathered shader call information. For example, if the user is not zooming in on the dinosaur skin, and thus, the input variable doDinosaurSkin is not being enabled, the compiler may generate a constraint having doDinosaurSkin set to false (F). In one embodiment, the compiler may generate a partially generic version that is sufficiently generic to cover the variation of shader calls exhibited during the run-time session. Furthermore, the compiler may dynamically update the partially generic version in response to dynamically gathered shader call information.

In the embodiments above, constraints have been described as being constraints on the input variables (i.e., the calling parameters) of the shader function. However, more generally, constraints may be constraints on input variables and state variables. (State variables are set by the system before calling the shader.) In other words, a constraint may include the specification of one or more state variables and/or the specification of one or more input variables.

Although the embodiments above have been described in considerable detail, other versions are possible. Numerous variations and modifications will become apparent to those skilled in the art once the present disclosure is fully appreciated. It is intended that the following claims be interpreted to embrace all such variations and modifications.

What is claimed is:

1. A method comprising:
(a) receiving input code for a program;
(b) compiling a specialized version V_{K} of the input code for each constraint C_{K} in a set of one or more constraints on input variables of the program and storing the specialized version V_{K} in a local memory,
(c) receiving particular values of the input variables in response to a run-time invocation of the program;
(d) searching the constraint set to determine if the particular values satisfy any of the constraints of the constraint set;
(e) in response to determining that the particular values satisfy a constraint C_{L} of the constraint set, invoking execution of the corresponding specialized version V_{L} by a target processor.

2. The method of claim 1 further comprising receiving the set of one or more constraints.

3. The method of claim 1, wherein said invoking execution of the specialized version V_{L} includes transferring the specialized version V_{L} from the local memory to the target processor.

4. The method of claim 1 further comprising the target processor executing the specialized version V_{L} once per vertex on a set of vertices in a first space.

5. The method of claim 4, wherein the first space is a virtual world space.

6. The method of claim 4, wherein the first space is a camera space.

7. The method of claim 4, wherein the vertices are vertices of micropolygons generated by a set of one or more tessellation processes.

8. The method of claim 1 further comprising:
in response to determining that the particular values satisfy two or more constraints of the constraint set, invoking execution of a specialized version V_{Kmin}, having a smallest estimated execution time from among the specialized versions corresponding to the two or more satisfied constraints, by the target processor.

9. The method of claim 1, wherein each of the constraints in the constraint set is defined by a corresponding compiler directive supplied by a programmer.

10. The method of claim 1, wherein the input code is written in a high-level language.

11. The method of claim 1, wherein the target processor has read and write access to a code cache, wherein said invoking comprises:
determining if the code cache contains a copy of the specialized version V_{L}, and
transferring the specialized version V_{L} from the local memory to the code cache only if the code cache does not contain a copy of the specialized version V_{L}.

12. The method of claim 11, wherein said invoking further comprises:
sending a command instructing the target processor to access the specialized version V_{L} from the code cache if the code cache contains a copy of the specialized version V_{L}.

13. The method of claim 1 further comprising:
compiling the input code to generate a generic version of the input code and storing the generic version in the local memory;
transferring the generic version from the local memory to the target processor in response to determining that the particular values satisfy none of the constraints of the constraint set.

14. The method of claim 1 further comprising:
compiling a specialized version V_{X} of the input code based on the particular values in response to determining that the particular values satisfy none of the constraints of the constraint set; and
invoking execution of the specialized version V_{X} by the target processor.

15. A graphical computing system comprising:
a host processor configured to execute instructions;
a target processor;
wherein, in response to execution of the instructions, the host processor is operable to: (a) receive input code for a program, (b) compile a specialized version V_{K} of the input code for each constraint C_{K} in a set of one or more constraints on input variables of the program and store the specialized version V_{K} in a local memory coupled to the host processor, (c) receive particular values of the input variables in response to a run-time invocation of the program, (d) search the constraint set to determine if the particular values satisfy any of the constraints of the constraint set, and (e) in response to determining that the particular values satisfy a constraint C_{L} of the constraint set, invoking execution of the specialized version V_{L} by the target processor.

16. The system of claim 15, wherein the host processor is further operable to receive the set of one or more constraints.

17. The system of claim 15, wherein said invoking of execution comprises transferring the specialized version V_{L} from the local memory to the target processor.

18. The system of claim 15, wherein the target processor is operable to execute the specialized version V_{L} once for each vertex in a set of vertices.

19. The system of claim 18, wherein the vertices of said set are vertices of micropolygons generated by a set of one or more tessellation processes.

20. The system of claim 15, wherein each of the constraints in the constraint set is specified by a corresponding compiler directive.

21. The system of claim 15, wherein the target processor has read and write access to a code cache, wherein said invoking includes:
determining if the code cache contains a copy of the specialized version V_{L}, and
transferring the specialized version V_{L} from the local memory to the target processor only if the code cache does not contain a copy of the specialized version V_{L}.

22. The system of claim 18, wherein said invoking includes:
send a command instructing the target processor to access the specialized version V_{L} from the code cache if the code cache contains a copy of the specialized version V_{L}.

23. The system of claim 15, wherein the host processor is further operable to:
compile the input code to generate a generic version of the input code and store the generic version in the local memory; and
transfer the generic version from the local memory to the target processor in response to determining that the particular values satisfy none of the constraints of the constraint set.

24. The system of claim 15, wherein the host processor is further operable to:
compile a specialized version V_{X} of the input code based on the particular values in response to determining that the particular values satisfy none of the constraints of the constraint set; and
transfer the specialized version V_{X} to the target processor.

25. The system of claim 15, wherein the target processor is included in a graphics accelerator system.

26. A memory medium configured to store computer readable instructions, wherein the computer readable instructions are executable to implement the operations of:
(a) receiving input code for a program;
(b) compiling a specialized version V_{K} of the input code for each constraint C_{K} in a set of one or more constraints on input variables of the program and storing the specialized version V_{K} in a local memory;
(c) receiving particular values of the input variables in response to a run-time invocation of the program;
(d) searching the constraint set to determine if the particular values satisfy any of the constraints of the constraint set; and
(e) in response to determining that the particular values satisfy a constraint C_{L} of the constraint set, invoking execution of the specialized version V_{L} by a target processor.

27. The memory medium of claim 26, wherein the target processor has read and write access to a code cache, wherein said invoking includes:
determining if the code cache contains a copy of the specialized version V_{L}, and
transferring of the specialized version V_{L} from the local memory to the target processor only if the code cache does not contain a copy of the specialized version V_{L}.

28. The memory medium of claim 26, wherein the program instructions are further executable to implement the operations of:
compiling the input code to generate a generic version of the input code and storing the generic version in the local memory; and
transferring the generic version from the local memory to the target processor in response to determining that the particular values satisfy none of the constraints of the constraint set.

29. The memory medium of claim 26 wherein the program instructions are further executable to implement the operations of:
compiling a specialized version V_{X} of the input code based on the particular values in response to a determination that the particular values satisfy none of the constraints of the constraint set; and
transferring the specialized version V_{X} to the target processor.

30. A graphical computing system comprising:
a means for processing stored instructions;
a means for rendering graphics data;
wherein, in response to execution of the stored instructions, the processing means is operable to: (a) receive input code for a program, (b) compile a specialized version V_{K} of the input code for each constraint C_{K} in a set of one or more constraints on input variables of the program and storing the specialized version V_{K} in a data storage means coupled to the processing means, (c) receive specified values of the input variables in response to a run-time invocation of the program, (d) search the constraint set to determine if the specified values satisfy any of the constraints of the constraint set, and (e) in response to determining that the specified values satisfy a particular constraint C_{L} of the constraint set, transferring the corresponding specialized version V_{L} from the data storage means to the rendering means.

31. A method for handling shader requests from a graphics application, the method comprising:
storing in a host memory a shader program that has N Boolean input parameters, wherein the shader program comprises a plurality of code sections, wherein N is greater than or equal to two, wherein each of the Boolean input parameters controls the execution of a corresponding code section of the shader program;
receiving a set of vectors, wherein each vector specifies a particular selection among the 2^{N} possible states for the N Boolean input parameters;
compiling a specialized version of the shader program for each of the vectors in said vector set;
storing the specialized versions in the host memory;
receiving a request for the execution of the shader program, wherein the request includes an input vector specifying particular values of the N Boolean input variables;
performing a comparison operation to determine if the input vector equals any of the vectors in said vector set;
invoking the execution of one of the specialized versions on a programmable processor in a graphics accelerator system in response to said comparison identifying a matching vector in said vector set.

32. The method of claim 31, wherein said invoking includes downloading said one of the specialized versions to a program memory in the graphics accelerator, wherein said program memory is accessible by the programmable processor.

33. The method of claim 31, wherein said invoking includes sending a command instructing the programmable processor to access and execute said one of the specialized versions from the program memory.

34. The method of claim 31, wherein said compiling comprises compiling a first specialized version of the shader program for a first of the vectors in said vector set, wherein values of the first vector determine inclusion of respective code segments of the program in the first specialized version.

35. A method for handling shader requests from a graphics application, the method comprising:
storing in a host memory a shader program that has N Boolean input parameters, wherein the shader program comprises a plurality of code sections, wherein N is greater than or equal to two, wherein each of the Boolean input parameters controls the execution of a corresponding one of the code sections of the shader program;
receiving a set of vectors, wherein each vector specifies a particular selection among the 2^{N} possible states for the N Boolean input parameters;
compiling an optimized version of the shader program for each of the vectors in said set;
storing the optimized versions in the host memory.

36. A method comprising:
receiving a request for execution of a shader function, wherein the request includes particular values for the input variables of the shader function;
determining if a pre-compiled specialized version of the shader function, corresponding to the particular values, is resident in a local memory;
invoking execution of the pre-compiled specialized version of the shader function by a programmable processor in a graphics accelerator system in response to determining that the pre-compiled specialized version is resident in the local memory.

37. The method of claim 36, wherein said invoking execution of the pre-compiled specialized version includes transferring the pre-compiled specialized version from the local memory to the graphics accelerator system.
